(19) United States
(12) Patent Application Publication
(10) Pub. No.: US 2023/0302742 A1
(43) Pub. Date: Sep. 28, 2023

(54) System for Pre-Assembling Site Materials

(71) Applicant: LCPR Inc., Thetford Mines (CA)

(72) Inventors: Pierre LaBonte, Thetford Mines (CA); Mario Perron, Thetford Mines (CA); Rene Roy, Mascouche (CA)

(21) Appl. No.: 18/188,641

(22) Filed: Mar. 23, 2023

Related U.S. Application Data
(60) Provisional application No. 63/269,780, filed on Mar. 23, 2022.

(51) Int. Cl. B29C 65/78; B29C 65/48; B29C 65/50; B29C 65/74

(52) U.S. Cl. CPC B29C 65/7861; B29C 65/4815; B29C 65/5057; B29C 65/7455

(57) ABSTRACT

A system for applying a protective overlay on construction tracks being carried along a work path is provided. The system includes an adhesive dispensing unit provided along the work path and has a dispenser operable to dispense adhesive to a surface of the construction tracks. The system also includes an overlay feeding unit operatively mounted about the work path and which has one or more feeder rolls adapted to guide and feed a length of protective overlay from a supply of protective overlay along a feeding course above the work path. The system further includes an affixing unit provided along the work path following the feeding course. The affixing unit includes an applicator adapted to generate an affixing force to secure the length of protective overlay from the feeding course on the construction tracks.

### CROSS-REFERENCE TO RELATED APPLICATIONS

This application claims priority under 35 USC § 119(e) of U.S. Provisional Patent Application No. 63/269,780 filed Mar. 23, 2022. That application is entitled “SYSTEM FOR PRE-ASSEMBLING SITE MATERIALS,” the entirety of which is hereby incorporated by reference.

### TECHNICAL FIELD

The technical field generally relates to a system for assembling construction site components, and more particularly, to a system adapted to apply adhesive and a protective overlay to steel tracks.

### BACKGROUND

Components used on construction sites typically require assembly on-site, be it to construct a structure comprising a plurality of components, such as construction tracks, or simply to assemble different parts to create the required component used in the construction of the structure. For example, insulated sheets can be assembled with (e.g., connected or adhered to) steel tracks prior to the construction of a structure. This insulation assembly is generally made by hand and is therefore susceptible to human errors.

Furthermore, assembling components on-site can mean assembling components outdoors. Therefore, the assembly has to be completed in any given weather conditions, such as (extreme) heat, in the cold, or in the rain. Such conditions can affect the quality of the assembled components.

Thus, it would be useful to be able to provide an apparatus or system which is able to overcome, or at least minimize, some of the drawbacks and/or deficiencies associated with conventional methods and/or devices, for example.

### SUMMARY

According to an aspect of the present disclosure, a system for applying a protective overlay on a construction track is provided. The system includes a conveying unit defining a work path and adapted to transport one or more construction tracks along the work path; a dispensing unit provided along the work path and comprising a dispenser operable to dispense adhesive to a surface of the construction tracks being transported along the work path; and an overlay feeding unit operatively mounted about the work path, the overlay feeding unit having one or more feeder rolls adapted to guide and feed a length of protective overlay from a supply of protective overlay along a feeding course above the work path; and an affixing unit provided along the work path following the feeding course, the affixing unit comprising an applicator adapted to apply the length of protective overlay from the feeding course on the construction tracks.

According to a possible embodiment, the protective overlay is made of polyethylene foam.

According to a possible embodiment, the protective overlay is made of closed-cell foam.

According to a possible embodiment, the protective overlay is made of ETHAFOAM™.

According to a possible embodiment, the construction track is made of metal.

According to a possible embodiment, the construction track is made of steel.

According to a possible embodiment, the adhesive comprises hot glue.

According to a possible embodiment, the adhesive comprises double-sided adhesive tape.

According to a possible embodiment, the system further includes an infeed rack adapted to hold a plurality of construction tracks side by side, and feed the construction tracks to the conveying unit.

According to a possible embodiment, the infeed rack is adapted to feed the construction tracks to the conveying unit one by one.

According to a possible embodiment, the conveying unit is operable to transport the construction tracks in an axial direction along the work path, and wherein the axial direction is generally parallel to respective longitudinal axes of the construction tracks.

According to a possible embodiment, the dispenser comprises a dispenser body positioned above the work path, the dispenser body comprising a dispenser outlet through which the adhesive is dispensed onto the construction tracks.

According to a possible embodiment, the dispenser body comprises a plurality of dispenser outlets.

According to a possible embodiment, the dispenser outlets are axially aligned along the dispenser body and adapted to dispense adhesive across a width of the construction tracks.

According to a possible embodiment, the applicator of the affixing unit comprises a roller press configured to press the protective overlay onto the surface of the construction tracks.

According to a possible embodiment, the supply of protective overlay comprises a roll of protective overlay configured to unroll to provide protective overlay along the feeding course, and the feeding unit is configured to feed the protective overlay to the roller press, and wherein operation of the roller press at least partially unrolls the roll of protective overlay.

According to a possible embodiment, the applicator comprises a pair of roller presses mounted along the work path.

According to a possible embodiment, the system further includes a severing unit operatively mounted along the work path, the severing unit comprising a cutter operable to cut the length of protective overlay once adhered to the construction tracks.

According to a possible embodiment, the severing unit is provided below the work path, and wherein the cutter is operable the cut the length of protective overlay from below.

According to a possible embodiment, the pair of roller presses are spaced from one another along the axial direction of the work path, and wherein the cutter is operable the cut the length of protective overlay between the pair of roller presses.

According to a possible embodiment, the affixing unit is adapted to apply the length of protective overlay being fed from the feeding unit on a first construction track, and the dispensing unit is adapted to dispense adhesive to the surface of a second construction track, simultaneously.

According to another aspect, a system for applying a protective overlay on construction tracks being carried along a work path is provided. The system includes an adhesive dispensing unit provided along the work path and comprising a dispenser operable to dispense adhesive to a surface of the construction tracks; an overlay feeding unit operatively mounted about the work path, the overlay feeding unit having one or more feeder rolls adapted to guide and feed a length of protective overlay from a supply of protective overlay along a feeding course above the work path; and an affixing unit provided along the work path following the feeding course, the affixing unit comprising an applicator adapted to generate an affixing force to secure the length of protective overlay from the feeding course on the construction tracks.

According to another aspect, a system for applying a protective overlay on a component being carried along a work path is provided. The system includes an adhesive dispensing unit provided along the work path and comprising a dispenser operable to dispense adhesive to a surface of the component, an overlay feeding unit operatively mounted about the work path, the overlay feeding unit having one or more feeder rolls defining a feeding course and adapted to support and guide a length of the protective overlay from a supply of the protective overlay along the feeding course; and an affixing unit provided along the work path proximate an end of the feeding course, the affixing unit comprising an applicator adapted to generate an affixing force to secure the length of protective overlay from the feeding course on the component.

According to another aspect, a method of applying a protective overlay on a component being carried along a work path is provided. The method includes, in an application stage, applying an adhesive to a surface of the component; in a provision stage, providing a length of the protective overlay from a supply to proximate the work path; in an affixing stage, affixing the length of protective overlay to the surface of the component via an affixing force; and cyclically repeating the application, the provision, and the affixing stages for each subsequent component.

According to an embodiment, the method further includes, in a severing stage, severing the length of protective overlay following the affixing stage to define a protected component.

According to an embodiment, the affixing stage comprises a primary affixing stage prior to the severing stage, and a secondary affixing stage following the severing stage, and wherein the affixing force is provided at a first location, a second location or both during the primary affixing stage, and wherein the affixing force is provided at the second location during the secondary affixing stage.

According to an embodiment, each component is carried along the work path one-by-one, and wherein the application stage of a second component is initiated prior to the severing stage of a first component.

According to an embodiment, each component is carried along the work path one-by-one, and wherein the application stage of a second component is initiated during the affixing stage of a first component.

### BRIEF DESCRIPTION OF THE DRAWINGS

FIG. 1 is a perspective view of an assembly system configured for pre-assembling materials and/or components, according to an embodiment.

FIG. 2 is a perspective view of an infeed rack of the assembly system shown in FIG. 1, for providing components to a conveyor belt, according to an embodiment.

FIG. 3 is a perspective view of a dispensing unit of the assembly system shown in FIG. 1, for dispensing adhesive onto components below, according to an embodiment.

FIG. 4 is a perspective view of the assembly system shown in FIG. 1, showing a roll of protective overlay being fed to an affixing unit, according to an embodiment.

FIG. 5 is a perspective view of the assembly system shown in FIG. 1, showing a length of the protective overlay extending along a feeding course, according to an embodiment.

FIG. 6 is an enlarged view of the assembly system shown in FIG. 5, showing an ejection mechanism, according to an embodiment.

FIG. 7 is an enlarged side view of the assembly system shown in FIG. 1, showing a pair of rollers of the affixing unit, according to an embodiment.

FIGS. 8 and 9 are perspective views of the affixing unit shown in FIG. 7, showing a severing unit in a retracted configuration (FIG. 8) and in an extended configuration (FIG. 9).

FIGS. 10 and 11 are rear perspective views of the assembly system shown in FIG. 1, showing a supply of adhesive and an adhesive pipe coupled to the dispensing unit, according to an embodiment.

### DETAILED DESCRIPTION

As will be explained below in relation to various embodiments, the present disclosure describes a system for pre-assembling materials and/or components, such as construction site materials, prior to shipping the assembled components to the construction site. The system can be referred to as an assembly system. More specifically, the system is adapted to apply a protective overlay, such as sheets of foam, on construction tracks, such as metallic tracks used in the construction of houses and buildings, among others. The system includes a conveying unit for transporting construction tracks along a predetermined work path, an adhesive dispensing unit configured to apply adhesive to the construction tracks, and an affixing unit configured to press, bond or otherwise connect the protective overlay to the construction track. The system also includes a feeding unit having a supply of protective overlay configured to supply lengths of the protective overlay to the affixing unit.

The system is configured to adhere a layer of protective foam to construction tracks being transported one by one, lengthwise along the work path. The supply of protective overlay continuously provides the protective overlay to the affixing unit during operation of the system. As such, and as will be further described below, the system can substantially continuously apply protective overlay on the construction tracks fed into the system.

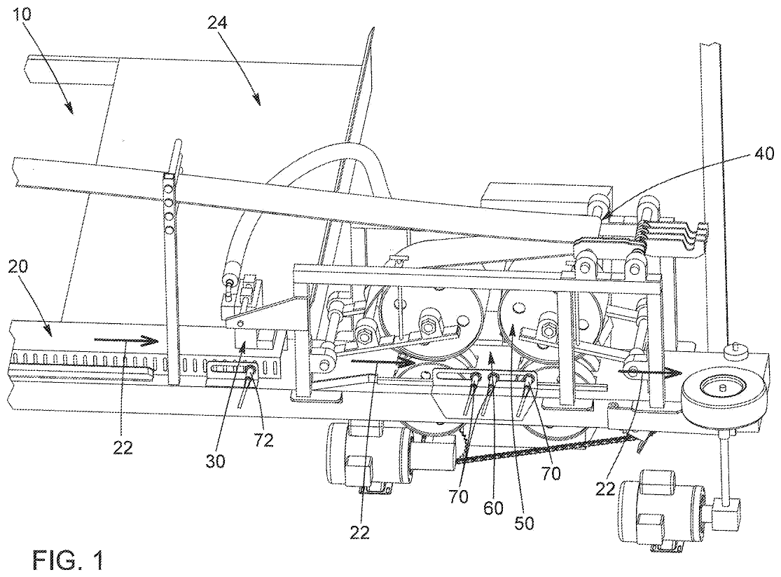

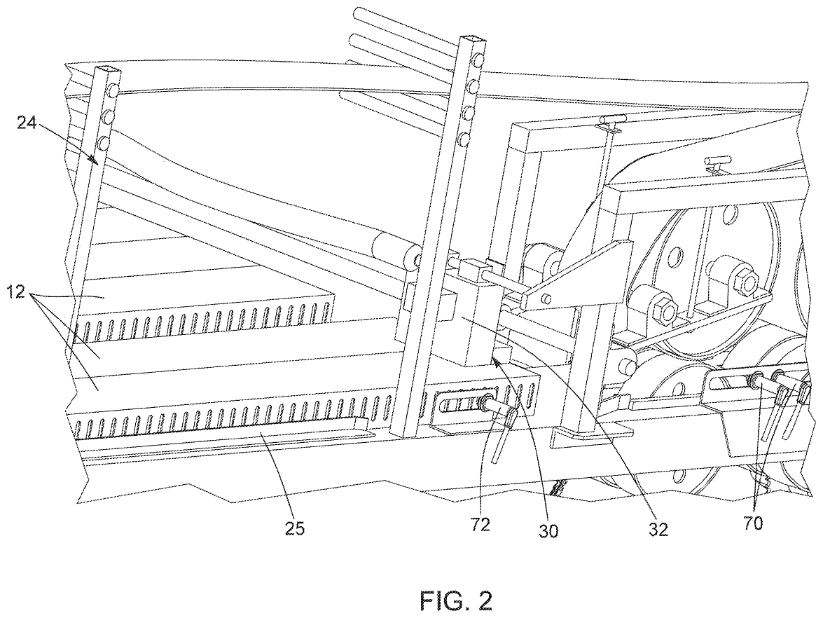

With reference to FIGS. 1 to 3, a system 10 (or assembly system) for pre-assembling components is shown in accordance with a possible embodiment. In this embodiment, the system 10 includes a conveying unit 20 adapted to transport components, such as construction tracks 12, along a work path 22. It should be understood that the work path 22 can be defined solely by the conveying unit 20 (e.g., along a conveyor belt) or by a combination of components and/or structural features of the assembly system. In some embodiments, the construction tracks 12 can be fed to the conveying unit 20 by an infeed rack 24 adapted to hold a plurality of construction tracks side by side, as seen in FIG. 2, and feed the construction tracks to the work path of the conveying unit 20. It should thus be understood that the infeed track 24 is positioned upstream (e.g., before) the conveying unit 20 of the system 10.

The infeed rack 24 can be configured to feed the construction tracks 12 to the conveying unit one by one, and can therefore define an input of the system 10, although other configurations are possible. In this embodiment, the infeed rack 24 is slanted such that the construction tracks provided thereon slide toward a bottom end thereof, and transfers to the conveying unit 20. The conveying unit can include a guard rail 25 configured to prevent the construction tracks from falling off the conveying unit 20 when transferring from the infeed rack 24. In other words, the construction tracks are adapted to abut against the guard rail 25, which simultaneously aligns them along the work path 22.

The conveying unit 20 can include any suitable mechanism(s) adapted to urge the construction tracks forward along the work path. For example, the conveying unit 20 can include a conveyor belt or other types of belt-driven conveyors, conveyor rollers, chain conveyor, drag conveyor, motorised-drive conveyor, pneumatic conveyors (e.g., pistons and/or pushers), auger conveyors, etc., or a combination thereof. In this embodiment, the conveying unit includes an input mechanism 28, such as a cylinder and/or a piston mechanism configured to urge the construction track forward along the work path once the construction track is unloaded from the infeed rack 24 and/or loaded onto the conveyor belt.

The input mechanism 28 can control the loading rate of the construction tracks onto the work path. For instance, the input mechanism 28 can be operated in an extended configuration, where a component thereof at least partially blocks an access between the infeed rack 24 and the work path. The input mechanism 28 can be further operated in a retracted configuration, where the access to the work path is allowed and one of the construction tracks (e.g., the lowermost construction track) can slide onto the work path. The input mechanism 28 can then be operated in the extended configuration once again to push the construction track forward along the work path, and simultaneously prevent a subsequent construction track from the infeed rack 24 to slide onto the work path. This process can be repeated to have the construction tracks be fed to the system 10 (e.g., to the work path) one-by-one.

The conveying unit can include a secondary mechanism configured to receive the construction track from the input mechanism 28 to maintain the forward motion of the construction track along the work path and through the system. In this embodiment, the conveying unit is operable to transport the construction tracks in an axial direction (e.g., in a generally straight line) along the work path. As seen in FIGS. 1 and 2, the transport direction of the construction tracks is generally parallel to respective longitudinal axes of the construction tracks.

The system 10 further includes a dispensing unit 30 provided along the work path 22 and operable to dispense an adhesive and/or a bonding agent to the construction tracks 12 being conveyed, or otherwise transported along the work path. It should be understood that, as used herein, the terms “adhesive agent” or “bonding agent” can refer to any substance and/or material that is capable of holding materials together in a functional manner by surface attachment that resists separation. For example, in some embodiments, the adhesive includes glue (e.g., hot glue), cement or paste. In other embodiments, the dispensing unit 30 can be adapted to dispense a bonding agent, such as a tape, and more specifically a double-sided tape. As will be described further below, the adhesive and/or bonding agent dispensed and/or applied to the construction tracks 12 enable the attachment or connection of a second component thereon.

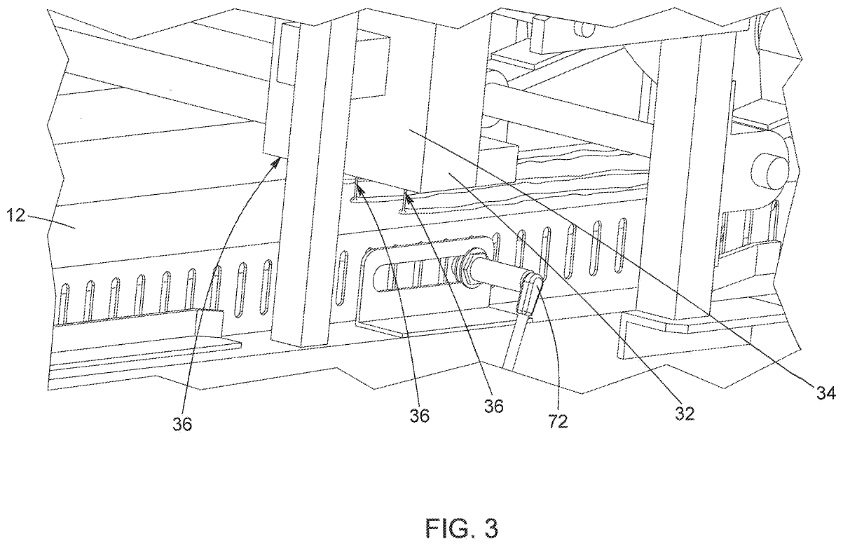

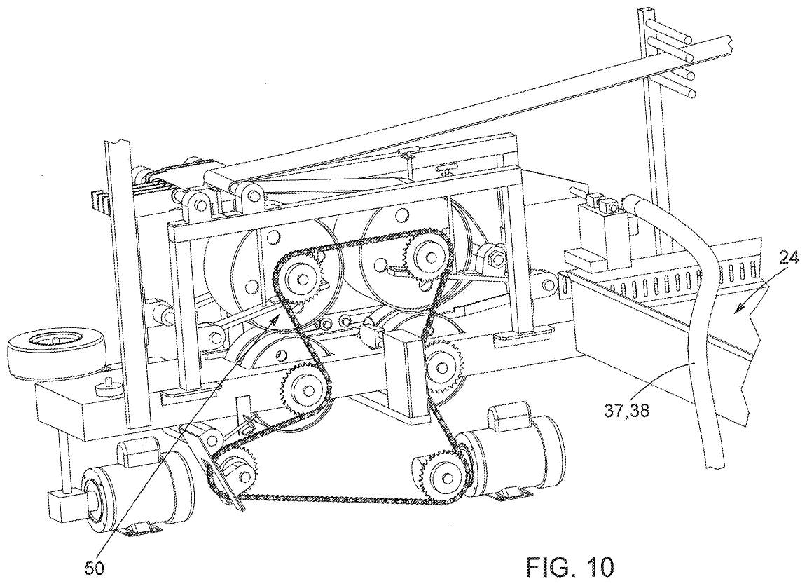

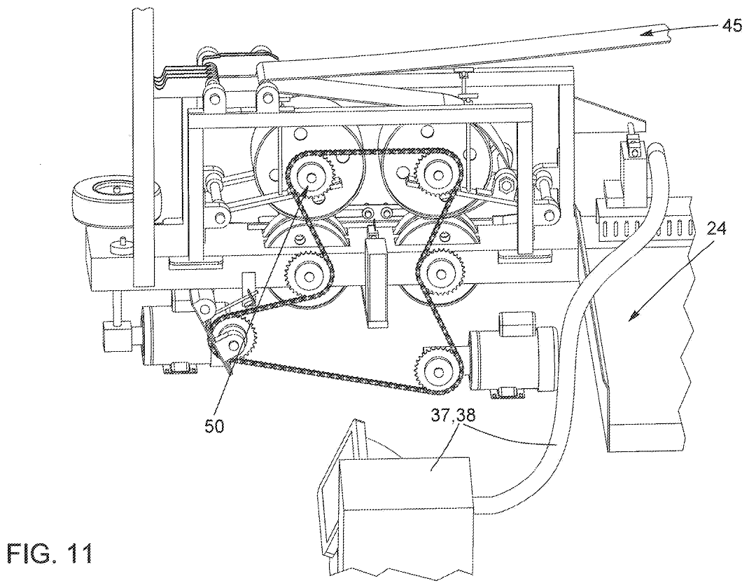

In some embodiments, the dispensing unit 30 can include a dispenser 32 operable to apply the adhesive to a surface of the construction tracks being transported along the work path. In this embodiment, the dispenser 32 has a frame or body 34 positioned above the work path 22, and therefore above the construction tracks being conveyed. It should thus be noted that the dispenser 32 is adapted to dispense the adhesive for application on a top surface (e.g., a top-facing surface) of the construction tracks 12. The body 34 can be operatively connected to a supply of adhesive 37 (seen in FIGS. 10 and 11), such as a supply of hot glue 38, and includes one or more dispenser nozzles or outlets 36 through which the adhesive is dispensed onto the construction tracks. It should be noted that the supply of hot glue 38 can be adapted to maintain the adhesive at a predetermined temperature, for example, to keep the hot glue in a melted state. The dispenser body 34 can include a single, large dispenser outlet 36 shaped and sized to dispense adhesive over a desired portion of the construction tracks. Alternatively, and as seen in FIG. 3, the body 34 can include a plurality of dispenser outlets 36 adapted to dispense adhesive over the construction tracks at various different locations.

It should be noted that the dispenser body of the present embodiment is generally stationary, and that adhesive is dispensed over most of the top surface of the construction tracks because of their movement along the conveying unit. However, it is appreciated that other configurations are possible, such as mounting the dispenser body to a movable part, such as a train or robotic arm. As such, the construction tracks can remain stationary as the dispenser body moves and dispenses adhesive over the construction tracks. In yet another embodiment, both the construction tracks and the dispenser body can be adapted to be displaced to dispense adhesive over the construction tracks.

In some embodiments, the dispenser outlets 36 are axially aligned along a bottom of the dispenser body for dispensing adhesive across a width of the construction tracks. The outlets 36 can alternatively be provided on the dispenser body 34 in any other suitable pattern and can include some overlap, for example, a pair of outlets can be aligned along the longitudinal axis of the tracks to provide backup in case an outlet malfunctions or becomes clogged.

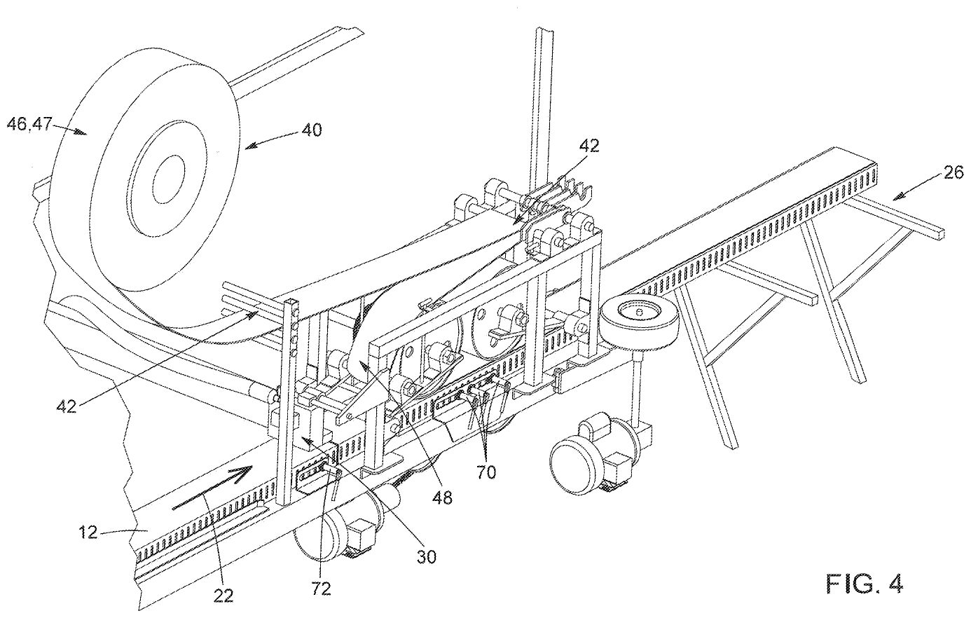

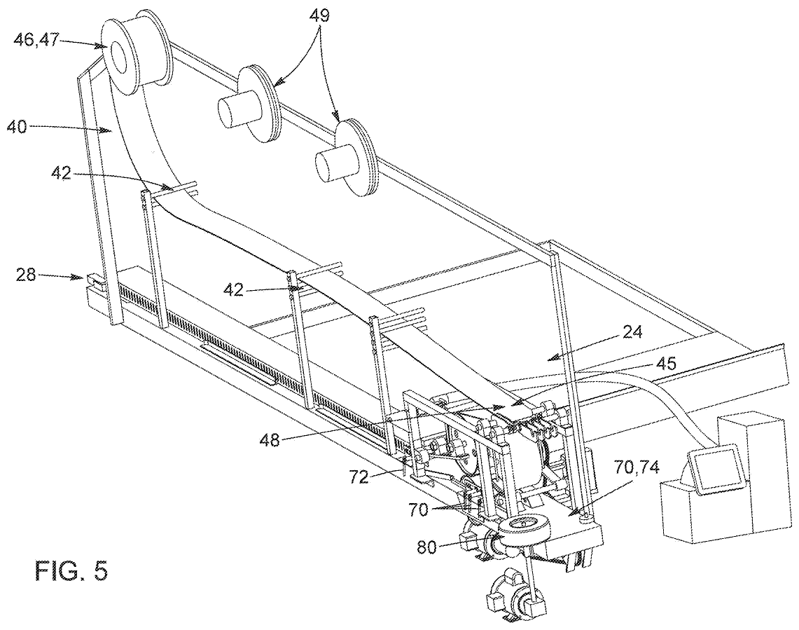

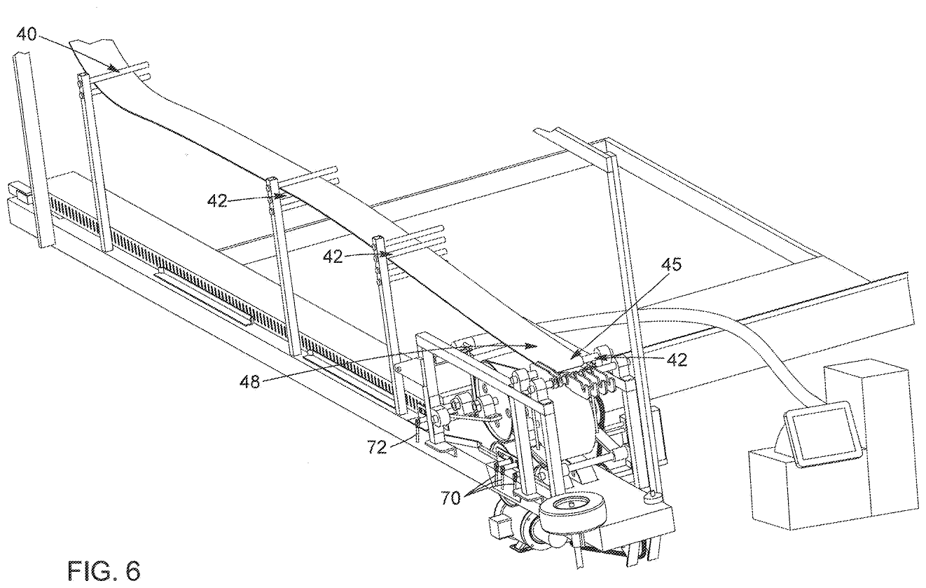

Now referring to FIGS. 4 to 6, in addition to FIG. 1, the system 10 can include a feeding unit 40 operatively mounted about the conveying unit 20. The feeding unit 40 has one or more feeding guides 42 adapted to guide a second component over the construction tracks 12 for connection therewith via the previously dispensed adhesive. In this embodiment, the feeding unit 40 is adapted to provide a length of protective overlay 45 from a supply of protective overlay 46 to the construction tracks. The supply of protective overlay 46 can include a roll of protective overlay 47 (as seen in FIGS. 4 and 5) provided on one or more supports 49 above the work path, which is adapted to unroll to provide lengths of protective overlay, or alternatively, stacks of individual sheets of protective overlay, for example. The feeding guides 42 define a feeding course 48 along which the length of protective overlay 45 can extend, and which ends substantially in alignment with the top surface of the construction tracks being transported along the work path 22. The length of protective overlay 45 contacts the adhesive and becomes attached to the construction track 12. As the construction track is conveyed along the work path 22, the supply of protective overlay 46 unrolls to provide additional lengths of protective overlay 45 to be applied along the desired length of the construction track 12 and/or any subsequent construction track(s).

It is noted that protective overlay is bonded to the construction track along at least the area which was provided with adhesive via the dispensing unit 30. As such, if the dispensing unit applied adhesive along an entire length of the construction track, the protective overlay is adapted to cover the entire length of the top surface of the construction track, for example. The length of protective overlay 45 provided from the supply can be shaped and sized to substantially match the width of the construction tracks being conveyed. Alternatively, the protective overlay can be cut after having been bonded to the construction tracks to match the width thereof. In some embodiments, the entire top surface area of the construction tracks is covered by the protective overlay, although other configurations are possible.

As seen in FIGS. 1 and 7 to 11, in this embodiment, the system 10 further includes an affixing unit 50 provided along the work path following the dispensing unit 30 for generating an affixing or bonding force adapted to fixedly connect the protective overlay to the construction tracks. The affixing unit 50 can include an applicator 52 adapted to press the length of protective overlay being fed from the feeding unit 40 onto the construction tracks 12. It is thus noted that, since the construction tracks are previously provided with adhesive (e.g., from the dispensing unit 30), the protective overlay is secured to the construction tracks as it is pressed on the top surfaces of the conveyed construction tracks, thereby defining a protected track.

It should also be noted that the affixing unit 50 is positioned proximate the end of the feeding course such that protective overlay can be fed to the construction tracks and to the applicator 52 generally simultaneously, or in quick succession. In this embodiment, the dispensing unit 30, the feeding unit 40 and the affixing unit 50 cooperate to enable a substantially continuous operation of the system 10. In some embodiments, the affixing unit 50 secures the protective overlay onto the construction tracks, which are conveyed along the work path. As such, the produced protected track “drags” the length of protective overlay being fed from the source of protective overlay 46 (e.g., from the roll of protective overlay 47) as it is being conveyed through the system 10. As the source of protective overlay unrolls after a first protected track is produced, protective overlay is continuously provided along the feeding course, and thus to a subsequent construction track 12. As will be described further below, the system 10 can include a severing unit configured to sever (e.g., cut) the length of protective overlay between adjacent construction tracks 12 to separate the produced protected tracks.

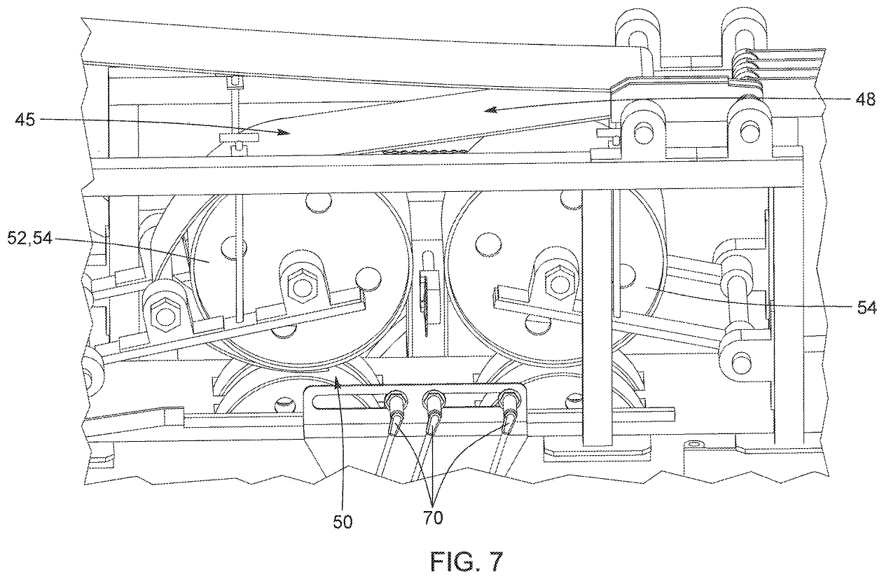

Still referring to FIGS. 7 to 11, in this embodiment, the applicator 52 includes a roller press 54 configured to press the protective overlay onto the surface of the construction tracks (i.e., configured to generate the affixing force. The roller press 54 can be adapted to assist in conveying the construction tracks along the work path 22 due to its rotating motion when pressing the protective overlay on the construction track. More specifically, the input mechanism 28 (see FIG. 5) can be adapted to urge the construction tracks fed from the infeed rack forward and into the affixing unit. From there, the roller press 54 conveys the construction track forward while simultaneously affixing the protective overlay onto the construction track. The affixing force generated by the roller press 54 can also assist in pulling on, or “dragging,” the length of protective overlay, which unrolls protective overlay from the source (e.g., from the roll 47). It is thus noted that the roller press 54 can be configured to perform a plurality of functions, including affixing the length of protective overlay to the construction track (e.g., as part of the affixing unit), urging the construction track forward (e.g., as part of the conveying unit), unroll protective overlay from the source (e.g., as part of the feeding unit), among others.

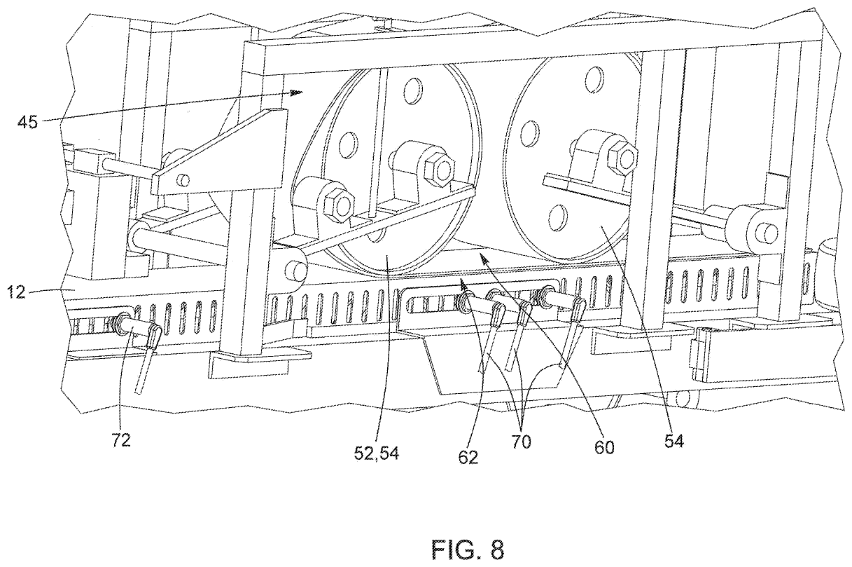

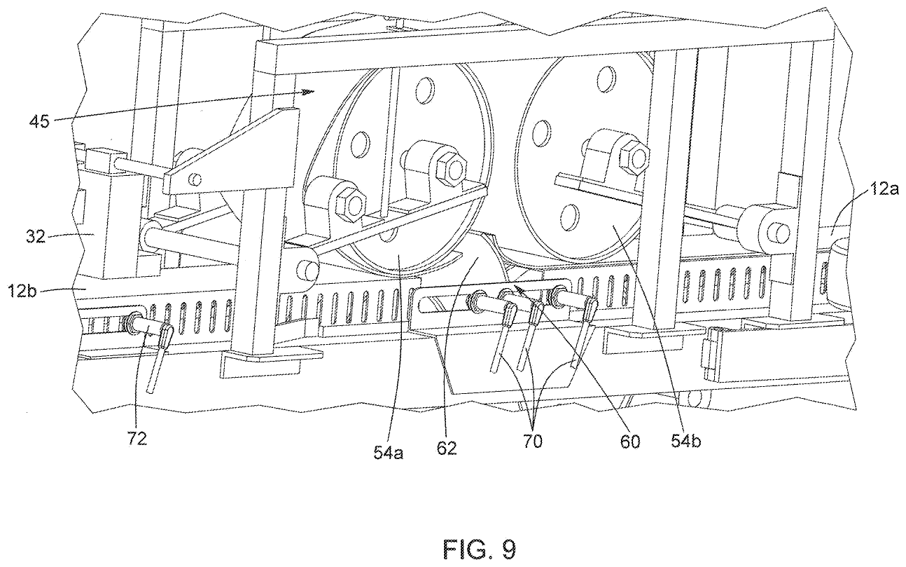

The applicator 52 can include a pair of roller presses 54 subsequently positioned along the work path 22 (e.g., aligned one behind the other). Each roller press 54 can be adapted to generate respective affixing forces to secure the protective overlay on the construction track. It is thus appreciated that a first roller press 54a is operable to generate a first affixing force at a first location along the work path, and the second roller press 54b is operable to generate a second affixing force at a second location along the work path. In some embodiments, the affixing force of the first roller press can be greater or less than the affixing force of the second roller press, although each roller press can be configured to generate substantially the same affixing force. As seen in FIGS. 8 and 9, the system 10 can include a severing unit 60 configured to sever the length of protective overlay at a desired location. For instance, the length of protective overlay 45 can be severed after having been applied and secured to a construction track. The produced protected track can then be removed from the system 10, with the remaining length of protective overlay 45 being applied to a subsequent construction track 12.

The severing unit 60 can include a cutter 62 operable between a retracted position (FIG. 8) and an extended position (FIG. 9) to cut the length of protective overlay 45, for example, once a protected track is produced. The cutter 62 is operable to engage the work path 22 in order to sever the length of protective overlay 45. In some embodiments, the cutter 62 is positioned below the work path 22, and is thus operable to cut the length of protective overlay from below. However, it is appreciated that the cutter can be provided at any other suitable location, such as laterally relative to the work path 22, for example. The severing unit 60 (e.g., the cutter 62) can be operated via any suitable method, such as pneumatically, hydraulically, or manually, for example. In some embodiments, the cutter 62 can be operated to engage the length of protective overlay via an axial movement, such as vertically (e.g., from below) or horizontally/laterally, via a rotational movement or a combination thereof. However, it is appreciated that other configurations and methods of having the cutter engage the length of protective overlay is possible and may be used.

In this embodiment, the pair of roller presses 54 are spaced from one another along the axial direction of the work path 22, thereby defining a gap therebetween. The cutter of the severing unit 60 is operable to engage the work path in the gap, and therefore cut the length of protective overlay between the pair of roller presses 54. As seen in FIG. 9, once a first construction track 12a has moved pass the first roller press 54a, and has thus been provided with the protective overlay, the cutter 62 cuts the length of protective overlay upstream of the first construction track 12a. At this point, the first construction track 12a is positioned below the second roller press 54b, which can then be operated to assist in moving the first construction track 12a toward an output of the system 10, which can include an outfeed rack 26 (FIG. 4).

The system 10 can include sensors 70, such as proximity and/or contact sensors provided at various locations along the work path to detect the presence (or absence) of a construction track. For example, an input sensor 72 can be provided proximate the bottom end of the infeed rack 24 to detect the presence of a construction track on the work path. The input sensor can send a signal to the input cylinder for operation thereof to urge the construction track forward. The sensors can also include one or more output sensors 74 proximate the output of the system (e.g., following the roller presses) to detect the presence of a construction track, which at this point would have had the protective overlay applied thereto. Once the presence of a construction track is detected, the one or more output sensors can send a signal to the severing unit to operate the cutter and sever the length of protective overlay. Alternatively, or additionally, the sensors 70 can include one or more central sensors positioned to detect the presence of a construction track between the pair of roller presses. For example, upon detecting the presence of a component, the roller presses are operated to affix protective overlay thereon and move the component forward. Once the central sensors no longer detect the component (i.e., detect an absence of components), a signal can be sent to the cutter for operation thereof to engage the gap and cut the length of protective overlay. The process can then be repeated with each subsequent component.

The system can be provided with an ejection mechanism 80 (e.g., output cylinder(s), robotic arm, rotating wheel(s), etc.) configured to urge or transport the construction track from the work path, following the roller presses, to the outfeed rack, for example. It is thus noted that the one or more output sensors can be adapted to send a signal to the ejection mechanism 80 once a construction track is detected proximate the outfeed rack, for example.

In this embodiment, during the severing operation of the length of protective overlay 45, a second construction track 12b is provided with adhesive and engages the first roller press 54a as the remaining length of protective overlay (i.e., after the severing operations) is secured to a first portion of the second construction track 12b. The cutter 62 then retracts from the work path to enable the second construction track 12b to move from the first roller press to the second roller press, moving pass the severing unit. The cutter then engages the work path once again to cut the length of protective overlay to produce a second protected track, which then moves toward the output of the system. It should thus be noted that various units of the system can operate simultaneously to enable a generally continuous production of protected tracks.

The construction tracks can be made of any suitable material, such as a metallic material, such as steel, for example, although other materials are possible and can be inputted in the system to secure a layer of protective overlay thereon. The construction tracks can further have any suitable shape, size (e.g., length, width, depth, thickness, etc.) and/or configuration onto which the protective overlay is secured. Similarly, the protective overlay can have any suitable shape, size (e.g., length, width, depth, thickness, etc.) and/or configuration enabling the application thereof onto a surface of the construction tracks. Furthermore, it should be noted that the assembly system 10 as described herein can be used to apply the protective overlay (e.g., insulation) to uncut, unformed and/or unmodified material, such as sheets of metal from a coil, for example. As such, the protective overlay can be applied prior to cutting and/or forming the material into a desired shape, size and configuration. The formed component can therefore be formed with the protective overlay already adhered thereto, which can increase manufacturing speed of protected and/or insulated components. It is also noted that cutting and forming the components after having had a layer of protective overlay applied thereto can enable the protective overlay (and the material itself) to be cut together such that the size and shape of the protective overlay conforms to the size and shape of the component.

As previously mentioned, the adhesive can include hot glue, which can be heated within the supply of hot glue to over 200° C., for example between 300° C. and 500° C., and/or double-sided tape. In some embodiments, the protective overlay includes a foam material, such as polyethylene foam. The foam material can be applied in layers configured to provide protection to the metallic construction tracks. In some embodiments, the foam material is a closed-cell foam, although other configurations are possible. In some embodiments, the foam material includes ETHAFOAM™. It is thus appreciated that the protective overlay can have insulating properties, protective properties, or both.

It should be appreciated from the present disclosure that the various embodiments of the system, various units and related components enable the production of protected constructed track in a generally continuous manner. The steel construction tracks can be loaded in the infeed rack, which feeds the construction tracks one by one to the conveying unit. The conveying unit then sends the construction tracks along the work path and below the dispensing unit, which applies adhesive onto the construction track via nozzles, outlets and/or jets of adhesive. As the construction track is urged along the work path, the feeding unit provides a layer of protective foam material, which is applied to the adhesive-covered surface of the construction track. The construction track is then fed into the affixing unit which generates a bonding or affixing force on the foam layer to secure it to the construction track via the adhesive, thereby creating a protected track. Following the affixing unit, sensors detect the presence of the protected track, which initiates the severing operation of the severing unit to cut the foam layer upstream of the protected track. The process can then be repeated with a subsequent construction track as the protected track is moved to the outfeed rack.

It is appreciated that, once a given stage of the assembly line is accomplished or completed for a first construction track, that stage can be initiated for a second construction track although the first construction track is still being conveyed through the system (e.g., in a subsequent stage to the completed stage). In other words, different units of the assembly system can be operated for different components simultaneously. For instance, adhesive can be provided to a second construction track while a first construction track is being conveyed below the roller presses to finalize adhering the protective layer there onto. Similarly, the second construction track can engage the first roller press during the severing operation following the adherence of the protective layer on the first construction track. It should also be understood that the dispensing unit can continue to dispense adhesive onto a given component while that same component has engaged the affixing unit. In other words, different units of the assembly system can be operated for a same component simultaneously.

The protected tracks can be bundled, such as in groups of even protected tracks, and strapped together to facilitate manipulation and transport of multiple protected tracks. The strapping operation can be done via a strapping unit (not shown) of the system, via an independent machine, or manually.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

The present system and corresponding units therefore provides several advantages over conventional devices and/or apparatus in that: a) on-site manual labor is reduced, therefore on-site work is completed faster; b) the quality of the product is increased (e.g., more precise, better adhesion, etc.) c) the protective layer does not disconnect (e.g., becomes unglued or damaged) during manipulation and/or transport; d) maintenance and repair costs are reduced; e) on-site installation is facilitated due to higher quality products; f) pre-assembly of protected tracks increases worker safety—no on-site assembly required, which can sometimes be accomplished under undesired weather conditions (rain, snow, frost, heatwaves, etc.).

As used herein, the terms “coupled,” “coupling,” “attached,” “connected,” or variants thereof can have different meanings depending in the context in which these terms are used. For example, the terms coupled, coupling, connected or attached can have a mechanical connotation. The terms coupled, coupling or attached can indicate that two elements or devices are directly connected to one another or connected to one another through one or more intermediate elements or devices via a mechanical element depending on the particular context. Similarly, in the context of the present disclosure, the expressions “unit,” “assembly,” “assemblage,” “subassembly,” “subsystem,” “mechanism,” “apparatus,” “component,” as well as any other equivalent expression and/or compound word(s) known in the art can be used interchangeably, as apparent to a person skilled in the art. This applies also for any other mutually equivalent expressions, such as, for example: “fastening,” “securing,” “locking,” “restraining,” “affixing,” “holding,” “adjusting,” or “coupling.” Also, in the context of the present description, expressions such as “can,” “may,” “might,” “will,” “could,” “should” or “would” may be used interchangeably, whenever appropriate, as also apparent to a person skilled in the art.

Furthermore, in the context of the present description, it will be considered that all elongated objects will have an implicit “longitudinal axis” or “centerline,” such as the longitudinal axis of a construction track, for example. Moreover, components of the present system(s) and/or steps of the method(s) described herein could be modified, simplified, altered, omitted and/or interchanged, without departing from the scope of the present invention, depending on the particular applications which the disclosed system is intended for, and the desired end results, as briefly exemplified herein and as also apparent to a person skilled in the art.

In the present disclosure, an embodiment is an example or implementation of the described features. The various appearances of “one embodiment,” “an embodiment” or “some embodiments” do not necessarily all refer to the same embodiments. Although various features may be described in the context of a single embodiment, the features may also be provided separately or in any suitable combination. Conversely, although the system and/or the associated units may be described herein in the context of separate embodiments for clarity, it may also be embodied in a single embodiment. Reference in the specification to “some embodiments,” “an embodiment,” “one embodiment,” or “other embodiments” means that a particular feature, structure, or characteristic described in connection with the embodiments is included in at least some embodiments, but not necessarily in all embodiments.

In the above description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

In addition, although the optional configurations as illustrated in the accompanying figures comprises various components and although the optional configurations of the assembly system as shown may consist of certain geometrical configurations as explained and illustrated herein, not all of these components and geometries are essential and thus should not be taken in their restrictive sense, i.e., should not be taken as to limit the scope of the present disclosure. It is to be understood that other suitable components and cooperations therein between, as well as other suitable geometrical configurations may be used for the embodiment and use of the assembly system, and corresponding parts, as briefly explained and as can be easily inferred here from, without departing from the scope of the disclosure.

1. A system for applying a protective overlay on a construction track, comprising:
a conveying unit defining a work path and adapted to transport one or more construction tracks along the work path;
a dispensing unit comprising a dispenser provided along the work path and operable to dispense adhesive to a surface of the construction tracks being transported along the work path; and
an overlay feeding unit comprising a supply support configured to support a supply of protective overlay, and one or more feeder rolls mounted about the work path and defining a feeding course, the overlay feeding unit being adapted to support, guide and feed a length of protective overlay from the supply of protective overlay, along the feeding course, and to the work path; and
an affixing unit comprising an applicator positioned along the work path proximate an end of the feeding course and adapted to apply the length of protective overlay from the overlay feeding unit to the construction tracks.

2. The system of claim 1, wherein the overlay feeding unit is adapted to support, guide and feed one or more sheets of at least one of polyethylene foam and closed-cell foam to the applicator of the affixing unit.

3. The system of claim 1, wherein the construction track is made of metal, and wherein the dispenser is operable to dispense hot glue on at least a top surface of the construction track.

4. The system of claim 1, wherein the construction track is made of metal, and wherein the dispenser is operable to dispense double-sided adhesive tape on at least a top surface of the construction track.

5. The system of claim 1, further comprising an infeed rack adapted to hold a plurality of construction tracks side by side, and operable to feed the construction tracks to the conveying unit one-by-one.

6. The system of claim 1, wherein the conveying unit is operable to transport the construction tracks in an axial direction along the work path, and wherein the axial direction is generally parallel to respective longitudinal axes of the construction tracks.

7. The system of claim 1, wherein the dispenser comprises a dispenser body positioned above the work path, the dispenser body comprising a dispenser outlet through which the adhesive is dispensed onto the construction tracks.

8. The system of claim 7, wherein the dispenser body comprises a plurality of dispenser outlets.

9. The system of claim 8, wherein the dispenser outlets are axially aligned along the dispenser body and adapted to dispense adhesive across a width of the construction tracks.

10. The system of claim 1, wherein the applicator of the affixing unit comprises a roller press configured to press the protective overlay onto the construction tracks.

11. The system of any one of claim 10, wherein the supply of protective overlay comprises a roll of protective overlay configured to unroll in order to provide a sheet of the protective overlay along the feeding course, and wherein operation of the roller press unrolls the roll of protective overlay as the protective overlay is pressed onto the construction track.

12. The system of claim 10, wherein the applicator comprises a pair of roller presses mounted along the work path.

13. The system of claim 12, further comprising a severing unit operatively mounted along the work path, the severing unit comprising a cutter operable to cut the length of protective overlay once adhered to the construction tracks.

14. The system of claim 13, wherein the cutter is operable the cut the length of protective overlay between the pair of roller presses.

15. A system for applying a protective overlay on a component being carried along a work path, comprising:
an adhesive dispensing unit provided along the work path and comprising a dispenser operable to dispense adhesive to a surface of the component;
an overlay feeding unit operatively mounted about the work path, the overlay feeding unit having one or more feeder rolls defining a feeding course and adapted to support and guide a length of the protective overlay from a supply of the protective overlay along the feeding course; and
an affixing unit provided along the work path proximate an end of the feeding course, the affixing unit comprising an applicator adapted to generate an affixing force to secure the length of protective overlay from the feeding course on the component.

16. A method of applying a protective overlay on a component being carried along a work path, comprising:
in an application stage, applying an adhesive to a surface of the component;
in a provision stage, providing a length of the protective overlay from a supply to proximate the work path;
in an affixing stage, affixing the length of protective overlay to the surface of the component via an affixing force; and
cyclically repeating the application, the provision, and the affixing stages for each subsequent component.

17. The method of claim 16, further comprising, in a severing stage, severing the length of protective overlay following the affixing stage to define a protected component.

18. The method of claim 17, wherein the affixing stage comprises a primary affixing stage prior to the severing stage, and a secondary affixing stage following the severing stage, and wherein the affixing force is provided at a first location, a second location or both during the primary affixing stage, and wherein the affixing force is provided at the second location during the secondary affixing stage.

19. The method of claim 17, wherein each component is carried along the work path one-by-one, and wherein the application stage of a second component is initiated prior to the severing stage of a first component.

20. The method of claim 16, wherein each component is carried along the work path one-by-one, and wherein the application stage of a second component is initiated during the affixing stage of a first component.
